(19) United States
(12) Patent Application Publication
(10) Pub. No.: US 2012/0002301 A1
(43) Pub. Date: Jan. 5, 2012

(54) ZOOM LENS APPARATUS HAVING MOVABLE LENS HOLDER

(75) Inventor: Koji NAKAJIMA, Saitama (JP)

(73) Assignee: FUJIFILM CORPORATION, Tokyo (JP)

(21) Appl. No.: 13/172,289

(22) Filed: Jun. 29, 2011

(30) Foreign Application Priority Data
Jul. 1, 2010 (JP) 2010-150919

(51) Int. Cl. G02B 7/10

(52) U.S. Cl. 359/700

(57) ABSTRACT

A zoom lens apparatus includes a movable magnification lens component, a stationary barrel, a movable lens holder, and a rotatable cam barrel. Plural cam grooves are formed in the cam barrel, have a pair of cam surfaces opposed to one another, for moving the movable lens holder in the optical axis direction by rotation of the cam barrel relative to the stationary barrel. Plural shaft devices are disposed on a peripheral surface of the movable lens holder, for extending in a radial direction being perpendicular to the optical axis direction. A cam follower device is secured to each of the shaft devices, and inserted in each of the cam grooves. A pair of cam follower surfaces are provided on the cam follower device, deformable resiliently about each of the shaft devices, and pressed by respectively the cam surfaces.

### BACKGROUND OF THE INVENTION

1. Field of the Invention

The present invention relates to a zoom lens apparatus having a movable lens holder. More particularly, the present invention relates to a zoom lens apparatus having a movable lens holder, in which a cam follower can be reliably kept engaged in a cam surface.

2. Description Related to the Prior Art

A zoom lens apparatus is widely used in combination with a camera, projector and other optical instruments. The zoom lens apparatus has a lens barrel and plural lens components. Relative positions of the lens components are changed to set the zoom lens apparatus at a desired zoom amount. Each of the lens components includes one or more lens optics and a lens holder for supporting the lens optics. One or more cam followers, for example three, are arranged on a peripheral surface of the lens holder. The zoom lens apparatus includes a stationary barrel and a cam barrel rotatable relative thereto. A linear groove is formed in the stationary barrel. A cam groove is formed in the cam barrel. Each cam follower is engaged with the linear groove and the cam groove, and is positioned according to relative positions of the linear groove and the cam groove. When the cam barrel rotates, the lens holder is moved along an optical axis.

The cam follower moves during contact with a cam surface of the cam groove and a side surface of the linear groove. Sufficient play or backlash is required between the cam follower and the surfaces of the linear groove and the cam groove. Should the play be too large, optical precision of the lens system will be low due to instability with the play. To raise high precision of the zoom lens apparatus, the play should be as small as possible. Also, reduction of a size and a manufacturing cost of the zoom lens apparatus is desired technically as well as the high precision.

JP-A 2002-318337 discloses a cam mechanism, in which the cam follower is rollers of an elliptical or oval shape. Two rollers are disposed to contact the cam groove and contact the linear groove. The cam mechanism includes a spring, which has ends retained to respectively the rollers, and biases the rollers in rotational directions opposite to one another. Two points on the periphery of the second roller are caused always to press the cam surfaces of the cam groove, so as to minimize the play between the cam follower and the cam groove.

The cam mechanism of JP-A 2002-318337 includes shafts, the first and second rollers, and a tension coil spring. The shafts project from the lens holder. The first and second rollers are supported on the shafts. The tension coil spring has ends retained on the first and second rollers, which are biased in directions opposite to one another. As a plurality of the lens holder are contained in the cam barrel and the stationary barrel, at first the shafts are fixed on the lens holder. Then the first roller, the tension coil spring and the second roller are assembled on the shafts in a sequence. Orientation of the second roller is limited by the cam groove. The tension coil spring must be shifted for biasing before the second roller can be retained on the end of the tension coil spring.

Thus, the tension coil spring and the first and second rollers according to the cam mechanism are inserted in the linear groove and the cam groove of the cam barrel and the stationary barrel in a state mounted on the shafts. The tension coil spring and the first and second rollers are assembled in a predetermined position of the lens holder which is disposed inside. The first and second rollers must be oriented for directions against the biases of the tension coil spring, and must be positioned in the linear groove and the cam groove of the cam barrel and the stationary barrel and inserted simultaneously. This is an extremely difficult operation, which is inconsistent to preference to simplified assemblage.

### SUMMARY OF THE INVENTION

In view of the foregoing problems, an object of the present invention is to provide a zoom lens apparatus having a movable lens holder, in which a cam follower can be reliably kept engaged in a cam surface.

In order to achieve the above and other objects and advantages of this invention, a zoom lens apparatus having a movable magnification lens component includes a stationary barrel. At least one movable lens holder is contained in the stationary barrel movably in an optical axis direction of the magnification lens component, for supporting the magnification lens component. A cam barrel is secured to the stationary barrel in a rotatable manner. Plural cam grooves are formed in the cam barrel, have a pair of cam surfaces opposed to one another, for moving the movable lens holder in the optical axis direction by rotation of the cam barrel relative to the stationary barrel. Plural shaft devices are disposed on a peripheral surface of the movable lens holder, for extending in a radial direction being perpendicular to the optical axis direction. A cam follower device is secured to each of the shaft devices, and inserted in each of the cam grooves. A pair of cam follower surfaces are provided on the cam follower device, for contacting respectively the cam surfaces in a resiliently deforming manner.

The cam follower surfaces are formed in positions opposite to one another in a profile surface of the cam follower device.

The cam follower device includes a central portion and an outer portion having the profile surface. An engaging hole is formed in the central portion, for receiving insertion of each of the shaft devices. A pair of through channels are formed to open between the central portion and the outer portion, for keeping the cam follower surfaces flexible.

The shaft devices and the engaging hole are shaped polygonally as viewed in a section, to prevent the cam follower device from rotating on the movable lens holder.

The cam follower device includes a pair of spring plates each of which includes first and second end portions, the first end portion being secured to each of the shaft devices, and the cam follower surfaces are disposed respectively at the second end portion.

Furthermore, plural recesses are formed in the peripheral surface of the movable lens holder in the radial direction. Plural shaft head portions are disposed at respectively one end of the shaft devices, fitted in respectively the recesses, for securing the shaft devices to the movable lens holder.

The plural recesses are arranged at points defined by equally dividing the peripheral surface of the movable lens holder.

The plural recesses are at least three recesses.

Preferably, the recesses are non-circular.

Each of the shaft devices includes a shaft section. A through hole is formed through a center of the shaft section. A screw is inserted in the through hole, for securing the shaft section inside each of the recesses.

Furthermore, a linear groove is formed in the stationary barrel to extend in the optical axis direction. A pad device is secured to each of the shaft devices in combination with the cam follower device, and inserted in the linear groove. A pair of pad surfaces are provided on the pad device, and pressed by side surfaces of the linear groove opposed to one another.

The cam grooves are inclined relative to the linear groove in a predetermined direction, and the cam follower surfaces are displaced from the pad surfaces according to the predetermined direction.

Consequently, a cam follower can be reliably kept engaged in a cam surface, because the shaft device and the contact pad device cooperate for continuing the engagement.

### BRIEF DESCRIPTION OF THE DRAWINGS

The above objects and advantages of the present invention will become more apparent from the following detailed description when read in connection with the accompanying drawings, in which:

FIG. 1 is a perspective view illustrating a zoom lens apparatus;

FIG. 2 is a vertical section illustrating the zoom lens apparatus;

FIG. 3 is an exploded perspective view illustrating a movable lens holder and a cam follower assembly;

FIG. 4 is a cross section illustrating portions of the movable lens holder and the cam follower assembly secured together;

FIG. 5 is a top plan illustrating insertion of a cam follower device in a cam groove;

FIG. 6 is a top plan illustrating a pad device in a linear groove;

FIG. 7 is a flow chart illustrating a process of securing the cam follower assembly;

FIG. 8 is a flow chart illustrating another preferred process of securing the cam follower assembly;

FIG. 9 is an exploded perspective view illustrating another preferred cam follower assembly.

### DETAILED DESCRIPTION OF THE PREFERRED EMBODIMENT(S) OF THE PRESENT INVENTION

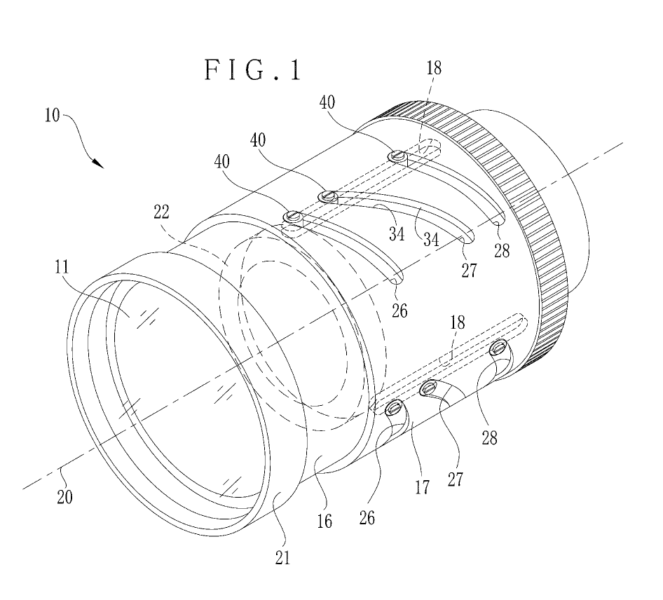

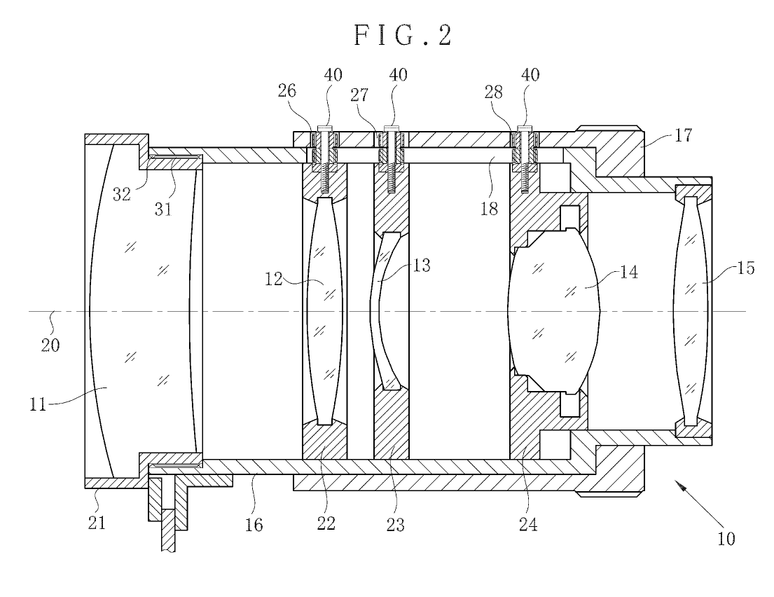

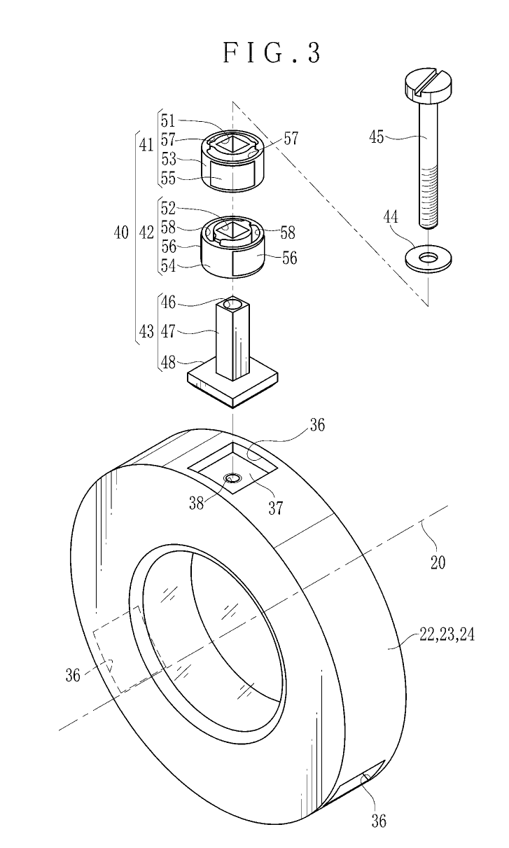

In FIGS. 1 and 2, a zoom lens apparatus 10 includes a lens system, a stationary barrel 16 for containing the lens system, and a cam barrel 17. The lens system includes a focusing lens component 11, magnification lens components 12, 13 and 14, and a rear lens component 15, each of which has one or more lens optics. A front lens holder 21 supports the focusing lens component 11. A male helical thread 31 is formed locally on a peripheral surface of the front lens holder 21. A female helical thread 32 is formed in the stationary barrel 16, and is engaged helically with the male helical thread 31. When the front lens holder 21 is rotated, the focus of the lens system is adjusted. Movable lens holders 22, 23 and 24 support respectively the magnification lens components 12-14. Three cam follower assemblies 40 of FIG. 3 are arranged on each of the peripheral surface of the movable lens holders 22-24. An optical axis 20 is defined in the lens system. The cam follower assemblies 40 are supported movably along the optical axis 20 by the stationary barrel 16. The rear lens component 15 is secured fixedly to the stationary barrel 16.

A linear groove 18 is formed in the stationary barrel 16 in parallel with the optical axis 20. The linear groove 18 is disposed at each of three points defined by equally dividing the peripheral surface of the stationary barrel 16 about the optical axis 20. Cam grooves 26, 27 and 28 are formed in the cam barrel 17, and are associated with respectively the magnification lens components 12-14. The cam groove 26 is disposed to extend on each one of three points defined by equally dividing the peripheral surface of the cam barrel 17. The cam grooves 27 and 28 are disposed in this manner. A pair of cam surfaces 34 are defined inside each of the cam grooves 26-28. For zooming of the lens system, the cam surfaces 34 rotate relative to the linear groove 18 so as to move the movable lens holders 22-24 in parallel with the optical axis 20. Thus, the magnification lens components 12-14 are moved. Note that the number of the magnification lens components 12-14 is not limited to three.

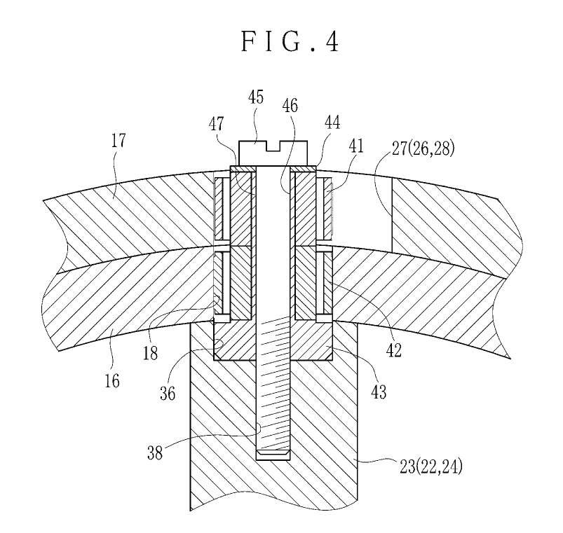

In FIGS. 3 and 4, recesses 36 of a square shape are formed in each of the movable lens holders 22-24, and arranged at three points defined by equally dividing their peripheral surface. A screw hole 38 is formed in a lower surface 37 of the recesses 36. Each of the cam follower assemblies 40 includes a cam follower device 41, a pad device 42, a shaft device 43, a washer 44 and a screw 45. The screw 45 is engaged helically with the screw hole 38 to secure the shaft device 43 to the movable lens holder 22, 23 or 24. The lower surface 37 of the recesses 36 is flat. The screw hole 38 is deep in a direction perpendicular to the optical axis 20. The cam follower assembly 40 extends in a radial direction perpendicular to the optical axis 20 about the movable lens holders 22-24.

The shaft device 43 includes an engaging shaft section 47 (key shaft or polygonal shaft) and a shaft head portion 48. A through hole 46 is formed in the engaging shaft section 47 for entry of the screw 45. The shaft head portion 48 is in a square shape and engageable with each one of the recesses 36 for firm retention. A quadrilateral engaging hole 51 or keyway opening is formed in the cam follower device 41 for receiving the shaft device 43. The cam follower device 41 includes a pair of cam follower surfaces 55 or first contact surfaces, and a pair of through channels 57. The cam follower surfaces 55 are symmetric with one another in an original profile surface 53 of the cam follower device 41. The through channels 57 are open between a central portion having the engaging hole 51 and outer portions having the cam follower surfaces 55, and extend in a direction along the original profile surface 53. The through channels 57 make the cam follower surfaces 55 bendable in a direction toward the engaging hole 51. Thus, the outer portions at the through channels 57 are deformed when external force is applied to the cam follower surfaces 55 toward the engaging hole 51. Return force occurs in the cam follower surfaces 55 against the external force.

The pad device 42 includes a quadrilateral engaging hole 52, a pair of pad surfaces 56 or second contact surfaces, and a pair of through channels 58. The engaging hole 52 is formed at the center of the pad device 42 for receiving the shaft device 43. The pad surfaces 56 in an original profile surface 54 are symmetric with one another. The through channels 58 are open between the engaging hole 52 and the pad surfaces 56. Note that the recess 36 and the shaft head portion 48 can be formed suitably in a non-circular shape for the purpose of preventing rotation of the shaft device 43. For example, the recess 36 and the shaft head portion 48 can be formed in a keyhole shape viewed in a cross section, as a composite shape of a circle and a straight segment.

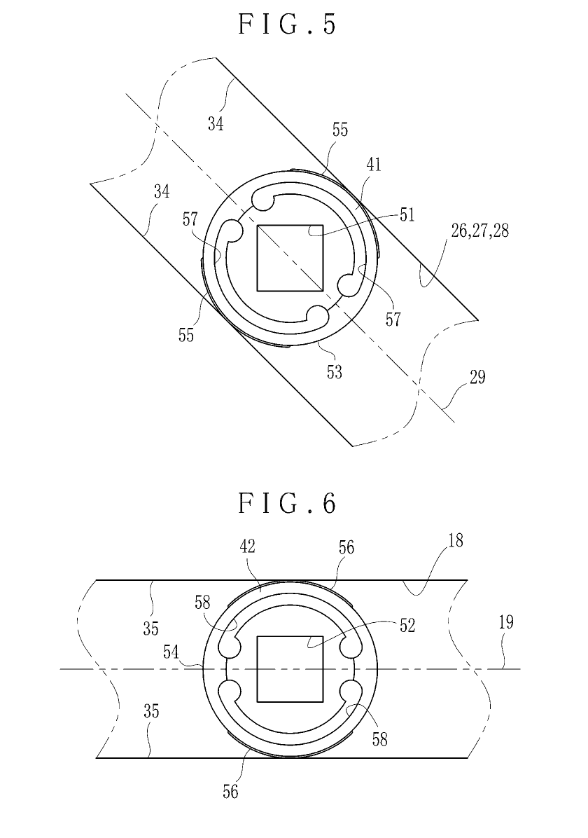

In FIG. 5, the cam follower surfaces 55 of the cam follower device 41 project from the original profile surface 53. The cam follower device 41 is mounted on the shaft device 43 for frictionally positioning on the cam surfaces 34. In FIG. 6, the pad surfaces 56 of the pad device 42 project from the original profile surface 54. A pair of side surfaces 35 are defined in the linear groove 18. The pad surfaces 56 are frictionally positioned on the side surfaces 35 to mount the pad device 42 on the shaft device 43. The cam follower surfaces 55 and the pad surfaces 56 are rotationally symmetric about the engaging hole 51. Positions of the pad surfaces 56 are different with a difference of 45 degrees from those of the cam follower surfaces 55. Note that the angle and relative positions of the cam follower surfaces 55 with respect to the engaging hole 51 can be optimized suitably according to shapes of the cam grooves 26-28.

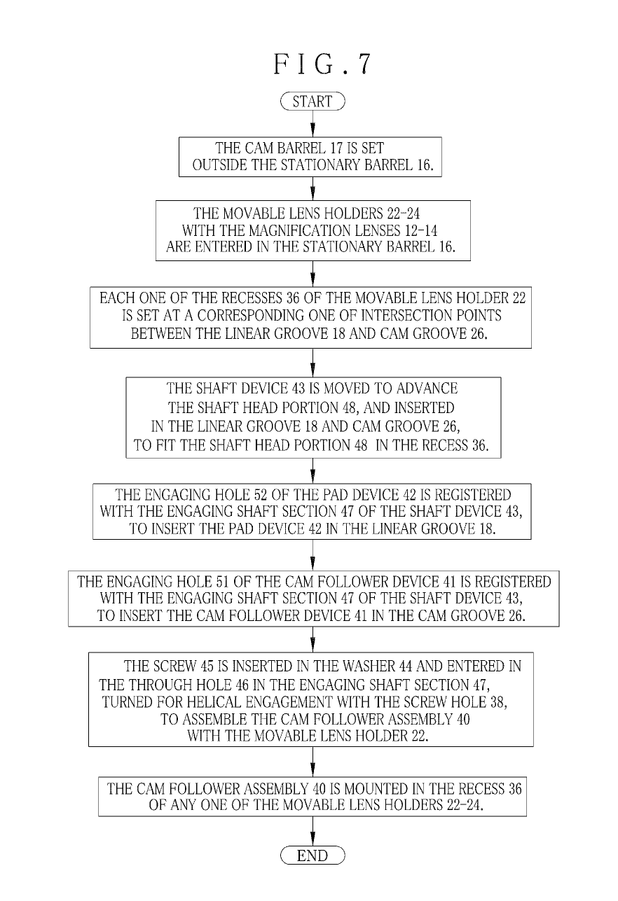

The assemblage and operation of the cam follower assembly 40 are described by referring to FIG. 7. The cam barrel 17 is set outside the stationary barrel 16. The movable lens holders 22-24 with the magnification lens components 12-14 are entered in the stationary barrel 16. See FIG. 4. Each one of the recesses 36 of the movable lens holders 22-24 is set at a corresponding one of intersection points between the linear groove 18 of the stationary barrel 16 and the cam grooves 26-28 of the cam barrel 17. The shaft device 43 is moved to advance the shaft head portion 48, and inserted in the cam grooves 26-28 and the linear groove 18, to fit the shaft head portion 48 tightly in the recess 36. The engaging hole 52 of the pad device 42 is registered with the engaging shaft section 47 of the shaft device 43, to insert the pad device 42 in the linear groove 18. As a diameter of the original profile surface 54 of the pad device 42 is slightly smaller than a width of the linear groove 18, the insertion can be easily carried out. Then the pad surfaces 56 are flexed slightly to insert the pad device 42 in the linear groove 18.

After the pad device 42 is inserted in the linear groove 18, the engaging hole 51 of the cam follower device 41 is registered with the engaging shaft section 47 of the shaft device 43 to insert the cam follower device 41 into each one of the cam grooves 26-28. As a diameter of the original profile surface 53 of the cam follower device 41 is slightly smaller than a width of the cam grooves 26-28, the cam follower device 41 can be easily inserted only by slightly bending the cam follower surfaces 55. Then the screw 45 is inserted in the washer 44 and entered in the through hole 46 in the engaging shaft section 47, turned for helical engagement with the screw hole 38, to assemble the cam follower assembly 40 with one of the movable lens holders 22-24. Finally, the cam follower assembly 40 is mounted in the recess 36 of any one of the movable lens holders 22-24.

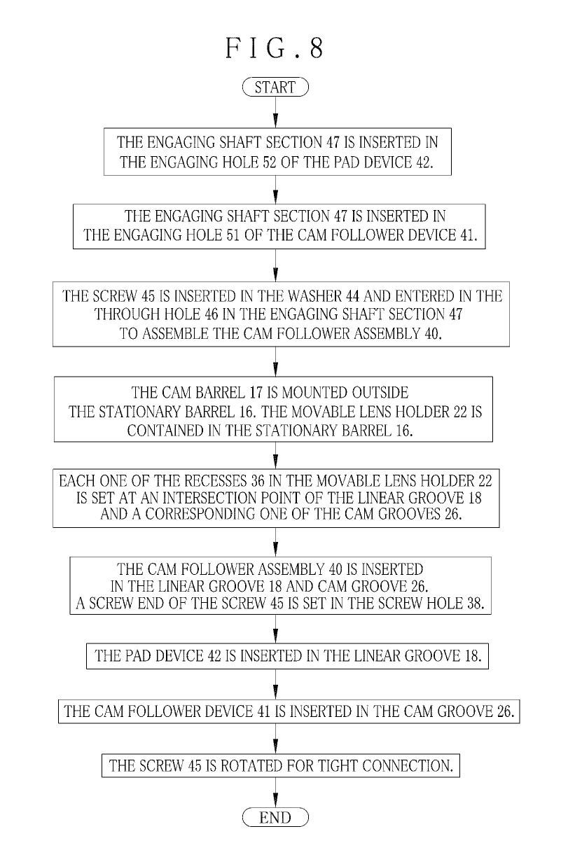

In FIG. 8, another preferred flow of assembling the cam follower assembly 40 on the movable lens holders 22-24 is illustrated. The engaging shaft section 47 of the shaft device 43 is inserted in the engaging hole 52 of the pad device 42, and then inserted in the engaging hole 51 of the cam follower device 41. The screw 45 is inserted in the washer 44 and entered in the through hole 46 in the engaging shaft section 47 to assemble the cam follower assembly 40. The cam barrel 17 is mounted outside the stationary barrel 16. The movable lens holders 22-24 with the magnification lens components 12-14 are contained in the stationary barrel 16.

Each one of the recesses 36 in the movable lens holders 22-24 is set at an intersection point of a corresponding one of the cam grooves 26-28 in the cam barrel 17 and the linear groove 18 in the stationary barrel 16. The cam follower assembly 40 as an assembly is inserted in the cam grooves 26-28 and the linear groove 18. A screw end of the screw 45 is set in the screw hole 38. The shaft head portion 48 is fitted in the recess 36 in helically engaging the screw 45 with the screw hole 38. The pad device 42 is inserted in the linear groove 18. The cam follower device 41 is inserted in the cam grooves 26-28. Then the screw 45 is rotated for tight connection before the assemblage is completed. The cam follower surfaces 55 or first contact surfaces always contact the cam surfaces 34 with friction. The pad surfaces 56 or second contact surfaces always contact the side surfaces 35 with friction. Thus, the shaft device 43 can be positioned at an intersection point between a center line 19 of the linear groove 18 (See FIG. 6) and a center line 29 of the cam grooves 26-28 (See FIG. 5).

Note that the cam follower device 41 and the pad device 42, although in the circular shape in the present embodiment, can be formed in other suitable shapes, for example, elliptic, parallelogram, rectangular quadrilateral and hexagonal shapes.

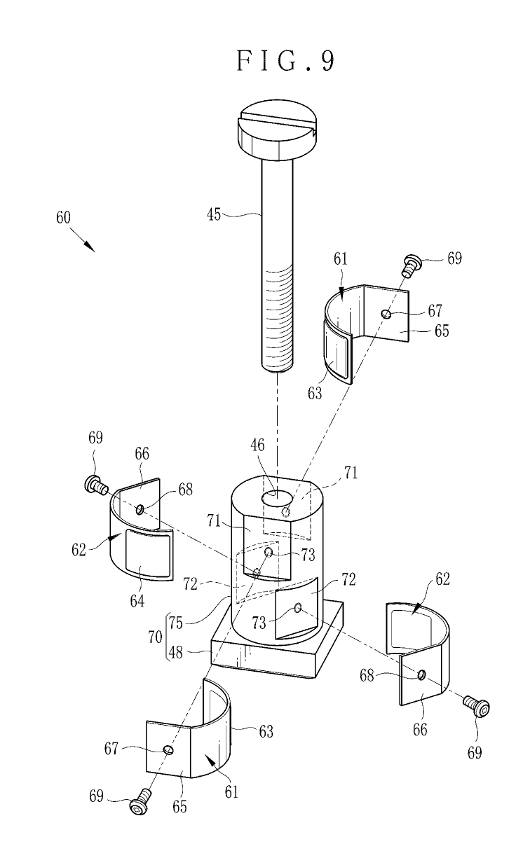

A cam follower assembly 60 of FIG. 9 is described next. Elements similar to those of the cam follower assembly 40 are designated with identical reference numerals. The cam follower assembly 60 includes a pair of first spring plates 61, a pair of second spring plates 62, a shaft device 70 and the screw 45. The first and second spring plates 61 and 62 are curved arcuately. A first end of the first and second spring plates 61 and 62 is disposed at a portion having cam follower surfaces 63 and pad surfaces 64. Base portions 65 and 66 of the first and second spring plates 61 and 62 are disposed at their second end, to extend flatly. Receiving holes 67 and 68 are formed at the center of the base portions 65 and 66. A fastening screw 69 is inserted in each of the receiving holes 67 and 68 for screw attachment.

The shaft device 70 includes a cylindrical shaft section 75, the shaft head portion 48 and the through hole 46. There are a pair of support surfaces 71 on the shaft section 75 for the screw attachment of the base portion 65 of the first spring plates 61. A pair of support surfaces 72 are used for the screw attachment of the base portion 66 of the second spring plates 62. The support surfaces 71 are disposed symmetrically about the through hole 46. Also, the support surfaces 72 are disposed symmetrically about the through hole 46. Each of the support surfaces 72 is rotationally displaced from one of the support surfaces 71 with a difference of an angle of 45 degrees. A screw hole 73 is formed in the support surfaces 71 and 72. The fastening screw 69 is helically engaged with the screw hole 73 for securing the base portions 65 and 66.

When the first spring plates 61 are secured to the shaft device 70 by way of a cam follower device, the cam follower surfaces 63 become arranged symmetric with one another about the shaft device 70. This is the situation for the second spring plates 62 as a pad device. Thus, the cam follower surfaces 63 are always pressed on the cam surfaces 34. The pad surfaces 64 are always pressed on the side surfaces 35, to position the shaft device 70 at an intersection point between the center line 29 of the cam grooves 26-28 and the center line 19 of the linear groove 18.

In the above embodiments, the cam barrel 17 is disposed outside the stationary barrel 16. However, a zoom lens apparatus of the invention may include the cam barrel 17 disposed inside the stationary barrel 16. Furthermore, a shaft for the pad device 42 can be separate for a shaft for the cam follower device 41 according to the invention. The zoom lens apparatus of the invention can be used for a camera, projector and other optical instruments.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A zoom lens apparatus having a movable magnification lens component, comprising:
a stationary barrel;
at least one movable lens holder, contained in said stationary barrel movably in an optical axis direction of said magnification lens component, for supporting said magnification lens component;
a cam barrel secured to said stationary barrel in a rotatable manner;
plural cam grooves, formed in said cam barrel, having a pair of cam surfaces opposed to one another, for moving said movable lens holder in said optical axis direction by rotation of said cam barrel relative to said stationary barrel;
plural shaft devices, disposed on a peripheral surface of said movable lens holder, for extending in a radial direction being perpendicular to said optical axis direction;
a cam follower device, secured to each of said shaft devices, and inserted in each of said cam grooves;
a pair of cam follower surfaces, provided on said cam follower device, for contacting respectively said cam surfaces in a resiliently deforming manner.

2. A zoom lens apparatus as defined in claim 1, wherein said cam follower surfaces are formed in positions opposite to one another in a profile surface of said cam follower device.

3. A zoom lens apparatus as defined in claim 2, wherein said cam follower device includes a central portion and an outer portion having said profile surface;
an engaging hole is formed in said central portion, for receiving insertion of each of said shaft devices;
a pair of through channels are formed to open between said central portion and said outer portion, for keeping said cam follower surfaces flexible.

4. A zoom lens apparatus as defined in claim 3, wherein said shaft devices and said engaging hole are shaped polygonally as viewed in a section, to prevent said cam follower device from rotating on said movable lens holder.

5. A zoom lens apparatus as defined in claim 2, wherein said cam follower device includes a pair of spring plates each of which is disposed outside one of said shaft devices and includes first and second end portions, said first end portion being secured to each of said shaft devices, and said cam follower surfaces are disposed respectively at said second end portion.

6. A zoom lens apparatus as defined in claim 2, further comprising:
plural recesses formed in said peripheral surface of said movable lens holder in said radial direction;
plural shaft head portions, disposed at respectively one end of said shaft devices, fitted in respectively said recesses, for securing said shaft devices to said movable lens holder.

7. A zoom lens apparatus as defined in claim 6, wherein said plural recesses are arranged at points defined by equally dividing said peripheral surface of said movable lens holder.

8. A zoom lens apparatus as defined in claim 6, wherein said plural recesses are at least three recesses.

9. A zoom lens apparatus as defined in claim 6, wherein said recesses are non-circular.

10. A zoom lens apparatus as defined in claim 6, wherein each of said shaft devices includes:
a shaft section;
a through hole formed through a center of said shaft section;
a screw, inserted in said through hole, for securing said shaft section inside respectively said recesses.

11. A zoom lens apparatus as defined in claim 2, further comprising:
a linear groove formed in said stationary barrel to extend in said optical axis direction;
a pad device, secured to respectively said shaft devices in combination with said cam follower device, and inserted in said linear groove;
a pair of pad surfaces, provided on said pad device, for pressing side surfaces of said linear groove opposed to one another.

12. A zoom lens apparatus as defined in claim 11, wherein said cam grooves are inclined relative to said linear groove in a predetermined direction.
